(19) United States
(12) Patent Application Publication
(10) Pub. No.: US 2026/0159449 A1
(43) Pub. Date: Jun. 11, 2026

(54) COMPOSITE POWDER CONTAINING YTTRIA AND METHOD FOR MANUFACTURING SAME

(71) Applicants: MiCo Ltd., Anseong-si (KR); KoMiCo Ltd., Anseong-si (KR)

(72) Inventors: Deul Kim, Anseong-si (KR); Sungyong Kim, Anseong-si (KR); Heejin Jo, Anseong-si (KR); Dae Sung Kim, Anseong-si (KR); Dong Hun Jung, Anseong-si (KR); Seongsik Bang, Anseong-si (KR); Yechan Kim, Anseong-si (KR)

(21) Appl. No.: 19/412,977

(22) Filed: Dec. 9, 2025

(30) Foreign Application Priority Data
Dec. 9, 2024 (KR) 10-2024-0181511

(51) Int. Cl. C04B 35/505; C04B 35/626; C04B 35/634; C23C 4/11; C23C 24/04

(52) U.S. Cl. CPC C04B 35/505; C04B 35/6261; C04B 35/62655; C04B 35/62695; C04B 35/634; C23C 4/11; C23C 24/04; C04B 2235/3206; C04B 2235/3225; C04B 2235/9669

(57) ABSTRACT

Provided are a method for manufacturing a composite powder and a composite granular powder manufactured by the method, the method including: preparing a slurry in which a yttria powder, a magnesia powder, a solvent, and an organic additive are mixed; performing ball milling on the slurry; and drying the slurry to produce a granular powder containing the yttria powder and the magnesia powder, wherein the granular powder contains yttria crystals and magnesia crystals.

### CROSS-REFERENCE TO RELATED APPLICATION(S)

This application is based on and claims priority under 35 U.S.C. 119 to Korean Patent Application No. 10-2024-0181511, filed on Dec. 9, 2024, in the Korean Intellectual Property Office, the disclosure of which is herein incorporated by reference in its entirety.

### BACKGROUND OF THE INVENTION

### 1. Field of the Invention

The present disclosure relates to a composite powder containing yttria and a method for manufacturing the same and, more specifically, to a composite powder having plasma etching resistance, which can be used in coating processes, such as thermal spray coating and aerosol deposition, and a method for manufacturing the same.

### 2. Description of the Prior Art

High-integration and ultra-fine line width techniques in semiconductor processes require plasma etching under extreme environment conditions, such as high-density plasma, high cleanliness, and excessive electric shocks. In particular, plasma etching using reactant gases containing a halogen element with strong chemical reactivity, such as F, Cl, or Br, involve etching of various deposition materials on the wafer surface, but provoke chemical and physical reactions with metal or ceramic components inside a chamber, thereby causing damage to the surface of the components and generation of non-volatile contaminant particles.

These contaminant particles critically affect the yield of final semiconductor devices, and therefore, components of plasma-resistant materials for minimizing the generation of contaminant particles are required. In recent years, interest has been greatly increasing in techniques for coating the surfaces of metal or ceramic components with ceramic materials exhibiting excellent plasma etching resistance. Typically, yttria or yttrium oxide (Y₂O₃) coating is widely applied.

Yttrium oxide exhibits a high melting point (2,450° C.), chemical stability, and crystallographic stability up to 2,300° C. Particularly, yttrium oxide exhibits excellent plasma resistance due to excellent chemical stability against F radicals, high ion-impact resistance resulting from the high atomic mass of yttrium, and excellent mechanical properties of the reaction product YF₃.

However, the reaction of the upper surface of a yttrium oxide coating layer with plasma gas, such as SF₆, CF₄, CHF₃, or HF at the initial stage of the etching process causes a change in the concentration of fluorine-based gas within the chamber. Consequently, the seasoning time in the etching process increases, and the yttrium oxide surface and the plasma gas react to form contaminant particles containing fluorine. Moreover, when yttrium oxide undergoes thermal cycling, stress arises due to a difference in the coefficient of thermal expansion between the contaminant particles and yttrium oxide, causing the detachment of the contaminant particles.

To address these problems, YF₃ with excellent corrosion resistance has been introduced, but YF₃ melts in the ultra-high-temperature plasma during atmospheric plasma spraying (APS), and a part of a fluoride is oxidized, resulting in a coating layer in which the fluoride and the oxide are partially mixed. Moreover, such a coating layer, compared with yttrium oxide spray-coated layers, may cause problems, such as cracking within the coating layer and frequent generation of contaminant particles in the etching chamber.

Meanwhile, the plasma resistance of plasma-resistant members depends on the grain size, and thus, as the grain size is larger, the roughness change after plasma etching is greater, causing reduced plasma resistance. Moreover, the larger the grain size, the larger the contaminant particles generated by plasma etching. Large contaminant particles cannot exit the chamber by fluid flow and are thus adsorbed onto the wafer, thereby hindering the operation of semiconductor devices and reducing yield. Therefore, a need exists for thermal spray coating of yttrium-oxide-based compounds having small particle sizes.

To prevent such contaminant particles, an attempt has been made to control the microstructure of a coating material. In sintered bodies produced by mixing yttrium oxide and magnesium oxide (MgO), two types of insoluble composites are formed and thus suppress each other's grain growth due to a mutual pinning effect. The sintered bodies with suppressed grain growth has smaller grains than conventional yttrium oxide sintered bodies, resulting in reduced surface roughness. Therefore, the generation of contaminant particles is reduced during plasma etching. However, when components in the chamber are manufactured from yttrium oxide or yttrium-oxide composite sintered bodies, process stability is degraded due to the brittleness of ceramic materials.

On the other hand, the hardness of plasma-sprayed coatings affects semiconductor process yield. A low coating hardness may result in the generation of contaminant particles due to plasma impact or high temperatures. Therefore, there is a need for thermal spray coating of high-hardness yttrium-oxide-based compounds.

### SUMMARY OF THE INVENTION

An aspect of the present disclosure is to provide a yttria-magnesia composite powder with plasma etching resistance, which can be used in coating processes, such as thermal spray coating and aerosol deposition.

In accordance with an aspect of the present disclosure, there is provided a method for manufacturing a composite powder, the method including: preparing a slurry in which a yttria powder, a magnesia powder, a solvent, and an organic additive are mixed; performing ball milling on the slurry; and drying the slurry to produce a granular powder containing the yttria powder and the magnesia powder, wherein the granular powder contains yttria crystals and magnesia crystals.

The slurry may be spray-dried to produce the granular powder.

The organic additive may be contained in an amount of 1 to 6 wt % relative to the total weight of the yttria powder and the magnesia powder.

The organic additive may contain a dispersant and a binder, and relative to 100 wt % of the organic additive, the dispersant may be contained in an amount of 30 to 90 wt % and the binder may be contained in an amount of 10 to 70 wt %.

The binder may be at least one of PVA, PVB, PVP, and PEO.

The RIR of the yttria powder to the magnesia powder contained in the granular powder may be 30:70 to 80:20.

The RIR of the yttria powder to the magnesia powder contained in the granular powder may be 35:65 to 79:21.

Relative to a total of 100 wt % of the yttria powder, the magnesia powder, and the solvent, the sum of the yttria powder and the magnesia powder may be 30 to 70 wt %.

In the granular powder, relative to a total of 100 vol % of the yttria powder and the magnesia powder, the volume ratio (vol %) of the yttria powder to the magnesia powder may be 30:70 to 70:30.

In accordance with another aspect of the present disclosure, there is provided a composite granular powder, containing a yttria powder and a magnesia powder, wherein the volume ratio (vol %) of the yttria powder to the magnesia powder is 30:70 to 70:30.

The composite granular powder may be produced by spray-drying a slurry in which the yttria powder, the magnesia powder, a solvent, and an organic additive are mixed.

The RIR of the yttria powder to the magnesia powder contained in the granular powder may be 30:70 to 80:20.

The RIR of the yttria powder to the magnesia powder contained in the granular powder may be 35:65 to 79:21.

According to embodiments of the present disclosure, contaminants particles within a chamber can be reduced by micronizing the crystalline phase.

Furthermore, according to embodiments of the present disclosure, the strength of the coating layer can be enhanced and the manufacturing cost can be reduced.

Furthermore, according to embodiments of the present disclosure, a coating having excellent plasma etching resistance can be formed on a component with a complex shape.

### BRIEF DESCRIPTION OF THE DRAWINGS

The above and other aspects, features and advantages of the present disclosure will be more apparent from the following detailed description taken in conjunction with the accompanying drawings.

FIG. 1 shows a flow chart illustrating a method for manufacturing a composite powder according to an embodiment of the present disclosure.

FIGS. 2A to 2G show SEM images of the granule surfaces according to examples and comparative examples of the present disclosure.

FIG. 3 shows EDS images of a granule according to an example of the present disclosure.

FIGS. 4A to 4G show graphs illustrating the XRD analysis results of the granular powders according to examples and comparative examples of the present disclosure.

FIGS. 5A to 5G show graphs illustrating the PSA analysis results.

FIGS. 6A to 6F show SEM images of coating layer sections for examples and comparative examples of the present disclosure.

FIGS. 7A and 7B illustrate the grain size distributions for Comparative Example 1 and Example 2.

FIGS. 8A and 8B illustrate crystalline structures for Comparative Example 1 and Example 2.

FIGS. 9A and 9B illustrate the crystallographic orientations for Comparative Example 1 and Example 2.

### DETAILED DESCRIPTION OF THE EXEMPLARY EMBODIMENTS

Hereinafter, embodiments of the present disclosure are described in detail with reference to the accompanying drawings, and similar or identical elements are assigned the same reference numerals irrespective of figure numbers, and redundant descriptions thereof are omitted. In the following description of the embodiments, it will be understood that, when a layer (or film), a region, a pattern, or a structure is referred to as being “on” or “under” another substrate, another layer (or film), another region, another pad, or another pattern, it can be “directly” or “indirectly” on the other substrate, layer (or film), region, pad, or pattern, or one or more intervening layers may also be present. Such a position of the layer has been described with reference to the drawings.

Additionally, the top/above, bottom/below, left/left side, right/right side, vertical (up/down), and horizontal (left/right) of each floor will be described with reference to the drawings. In the drawings, the thickness or size of each layer is exaggerated, omitted, or schematically illustrated for convenience and clearness of description. In addition, the size of each element does not fully represent its actual size.

It should be understood that the terms “comprise”, “include”, “composed of”, and the like herein specify certain features, numbers, steps, operations, elements, or some or combinations thereof, but do not preclude the presence or possibility of one or more other features, numbers, steps, operations, elements, or some or combinations thereof in addition to the description.

The terms first, second, and the like may be used herein to describe various elements. These elements should not be limited by these terms, as these terms are only used to distinguish one element from another unless stated otherwise or the context clearly indicates otherwise.

The term “about” or the like may indicate the usual error margin for each value, which is readily known to a person skilled in the art, and the term “about” or the like may indicate ±0.5% or up to 1% of the indicated value. Additionally, the term “about” or the like may indicate a measurement error due to the limitations of the measuring method.

In the description of embodiments herein, a detailed description of known techniques associated with the present disclosure may be omitted to avoid unnecessarily obscuring the subject matter of the present disclosure.

The accompanying drawings are intended to facilitate the understanding of embodiments herein, and the technical spirit disclosed herein is not limited by the accompanying drawings, and rather should be construed as including all the modifications, equivalents and substitutes within the spirit and technical scope of the present disclosure.

Hereinafter, embodiments of the present disclosure will be described with reference to the accompanying drawings.

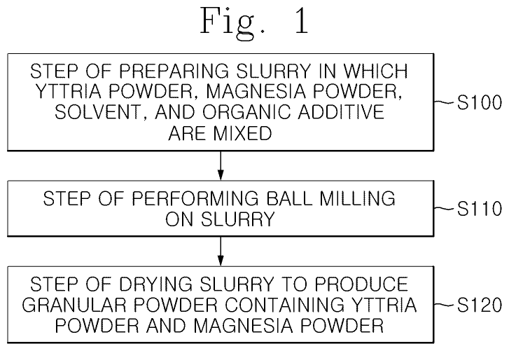

FIG. 1 shows a flow chart illustrating a method for manufacturing a composite powder according to an embodiment of the present disclosure.

Referring to FIG. 1, a method for manufacturing a composite powder according to an embodiment of the present disclosure includes: a step of preparing a slurry in which an yttria powder, a magnesia powder, a solvent, and an organic additive are mixed (S100); a step of performing ball milling on the slurry (S110); and a step of drying the slurry to produce a granular powder containing the yttria powder and the magnesia powder (S120). Particularly, relative to a total of 100 wt % of the yttria powder, the magnesia powder, and the solvent, the sum of the yttria powder and the magnesia powder may be 30 to 70 wt %. Additionally, in the granular powder, relative to a total of 100 vol % of the yttria powder and the magnesia powder, the volume ratio (vol %) of the yttria powder to the magnesia powder may be 30:70 to 70:30.

The composite powder according to an embodiment of the present disclosure may be a composite powder containing yttria (or yttrium oxide, Y₂O₃) and magnesia (or magnesium oxide, MgO). The composite powder according to an embodiment of the present disclosure may be preferably a granular powder.

In an embodiment of the present disclosure, for example, a composite granular powder in which the yttria and magnesia powders are mixed at a volume ratio (vol %) of 30:70 to 70:30 may be manufactured using spray drying. If the volume fraction of either yttria or magnesia is below 30 vol % or above 70 wt %, the insoluble composite granular powder thus manufactured may fail to exert a mutual pinning effect. The absence of the mutual pinning effect results in yttria and magnesia being unable to suppress each other's grain growth, thereby failing to achieve microstructure control. Consequently, the material occupying the larger volume between yttria and magnesia undergoes grain growth, causing an increase in the grain size of the composite granular powder.

Hereinafter, the method for manufacturing a composite powder according to the embodiment of the present disclosure will be described in detail.

To manufacture a composite granular powder by spray drying, a slurry is prepared as below.

The slurry is prepared by adding a total of 30 to 70 wt % of yttria and magnesia powders and 30 to 70 wt % of a solvent (ethanol), relative to 100 wt % of the slurry excluding an organic additive. With respect to the ratio of the yttria powder and the magnesia powder, the yttria powder in an amount of 30 to 70 vol % and the magnesia powder in an amount of 70 to 30 vol % are added relative to a total of 100 vol % of the powder volume. The organic additive is added in an amount of 1 to 6 wt % of the total weight of the two ingredients, the yttria powder and the magnesia powder. In 100 wt % of the organic additive, 30 to 90 wt % of a dispersant and 10 to 70 wt % of a binder are contained.

If either of the yttria or magnesia powder is below 30 vol % or above 70 wt %, the insoluble composite granular powder thus manufactured may fail to exert a mutual pinning effect. The yttria powder is used in the form of cubic-shaped particles with a particle size of 3 to 5 μm, and the magnesia powder is used in the form of cubic-shaped particles with a particle size of 0.1 to 1 μm. In an embodiment of the present disclosure, the yttria powder and/or the magnesia powder may be a primary powder or primary powders.

The organic additive, when added in an amount below the value described above, may result in decreased granule strength, thereby affecting heat treatment, a subsequent process and increasing the amount of fine particles. The organic additive, when added in an amount above the value described above, may result in increased slurry viscosity, thereby posing difficulty in slurry addition and causing non-uniform granule shapes.

The dispersant is added to facilitate the dispersion of each ingredient and to provide viscosity for ensuring uniformity during the formation of a coating layer, and at least one of a polyacrylate salt, polymethacrylic acid, polycarboxylic acid, and an ether may be used as the dispersant. The dispersant, when added in an amount below 30 wt %, may exhibit an insignificant effect, whereas the dispersant, when added in an amount above 90 wt %, may reduce the packing density of granules and cause non-uniform granule shapes.

The binder is added to enhance the adhesion between granules during press-molding of the granules, thereby imparting strength to molded bodies, and at least one of PVA, PVB, PVP, and PEO may be used as the binder. The binders, such as PVA, PVB, PVP, and PEO, exhibit excellent compatibility with the solvent and the powders. Additionally, such binders are also superior in terms of slurry stability including viscosity and solubility. The binder, when added in an amount below 10 wt %, may cause difficulty in strength enhancement, whereas the binder, when added in an amount above 70 wt %, may increase the viscosity of the slurry, causing defects during spray drying.

A ball milling process is performed at 200 to 350 rpm for 40 hours or shorter.

The slurry thus prepared is spray-dried to manufacture granules. The granulation may be a process of forming a powder mixture into agglomerates. In an example of the present disclosure, a rotary atomizer was used as a spray-drying apparatus, but the present disclosure is not limited thereto.

The spray-drying apparatus was set with an inlet temperature of 80-120° C. and a rotary atomizer disk speed of 3,000-30,000 RPM.

If the inlet temperature of the spray-drying apparatus is below 80° C., granules may not be properly formed, and sufficient drying may not be achieved, causing granules to stick together, forming agglomerates, or causing incompletely dried granules to adhere to the chamber walls of the atomizer. If the inlet temperature of the spray-drying apparatus is above 120° C., granules may have non-uniform shapes or non-spherical grains may be formed.

If the rotation speed of the rotary atomizer disk (atomizer speed) is below 3,000 RPM, large droplets may be generated due to a low rotation speed, and thus are not sufficiently dried in the chamber, whereas if the rotation speed of the rotary atomizer is above 30,000 RPM, fine grains may be generated, resulting in a reduction in yield.

In an embodiment of the present disclosure, the inlet temperature is preferably about 100° C., and the rotation speed of the rotary atomizer disk is preferably about 12,500 RPM. Through the spray drying according to an embodiment of the present disclosure, granules with a D50 of 30 to 40 μm were manufactured.

### EXPERIMENTAL EXAMPLES

Table 1 shows mixing ratios of the primary powders.

TABLE 1

| | | Mixing ratio (vol %) of |
|---|---|---|
| Mixed Powder | Ingredient | primary powders |
| Preparation Example 1 | Y₂O₃ | 100 |
| Preparation Example 2 | Y₂O₃ | 99 |
| | MgO | 1 |
| Preparation Example 3 | Y₂O₃ | 90 |
| | MgO | 10 |
| Preparation Example 4 | Y₂O₃ | 70 |
| | MgO | 30 |
| Preparation Example 5 | Y₂O₃ | 50 |
| | MgO | 50 |
| Preparation Example 6 | Y₂O₃ | 30 |
| | MgO | 70 |
| Preparation Example 7 | Y₂O₃ | 10 |
| | MgO | 90 |

Each of the prepared mixed powders in Table 1 was subjected to spray drying. Table 2 shows spray process conditions for the examples and comparative examples of the present disclosure.

TABLE 2

| | | Atomizer | | |
|---|---|---|---|---|
| | | rotation | | Inlet |
| | | speed | Milling | temperature |
| Classification | Mixed powder | (RPM) | time | (° C.) |
| Comparative | Preparation | 12,500 | 20 | 100 |
| Example 1 | Example 1 | | | |
| Comparative | Preparation | 12,500 | 20 | 100 |
| Example 2 | Example 2 | | | |
| Comparative | Preparation | 12,500 | 20 | 100 |
| Example 3 | Example 3 | | | |
| Example 1 | Preparation | 12,500 | 20 | 100 |
| | Example 4 | | | |
| Example 2 | Preparation | 12,500 | 20 | 100 |
| | Example 5 | | | |
| Example 3 | Preparation | 12,500 | 20 | 100 |
| | Example 6 | | | |
| Comparative | Preparation | 12,500 | 20 | 100 |
| Example 4 | Example 7 | | | |

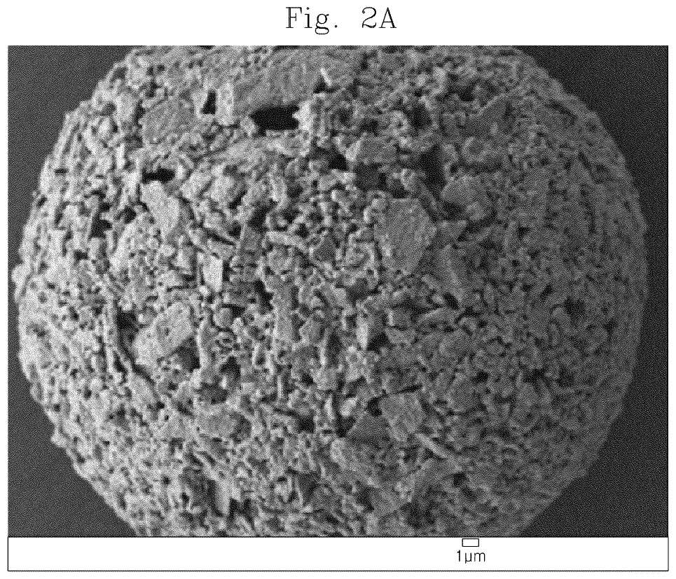

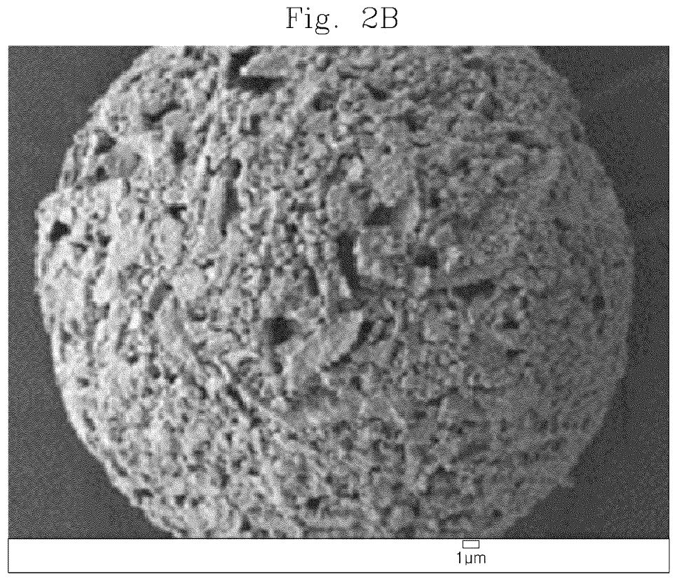

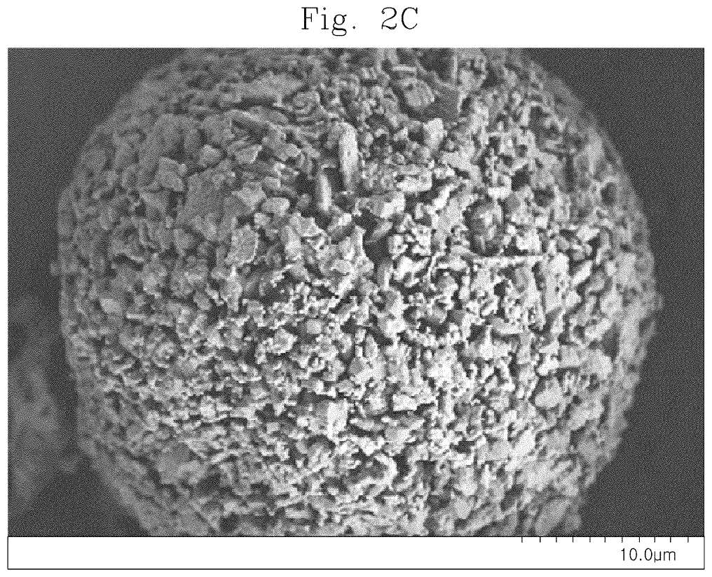

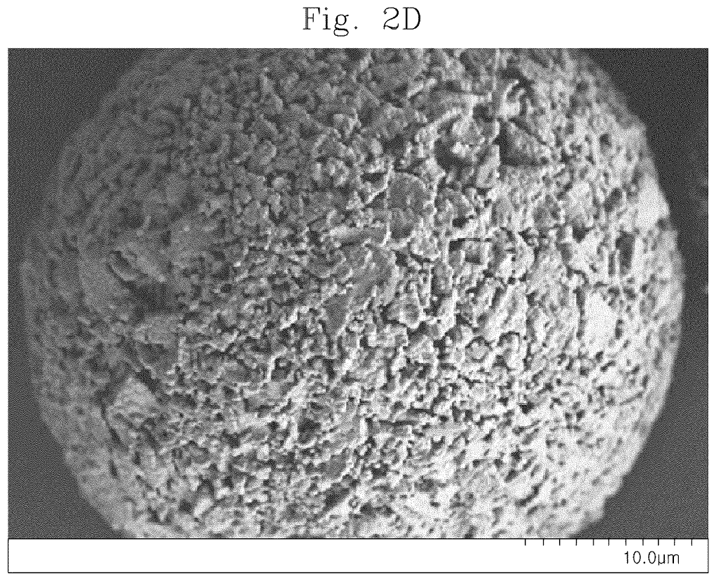

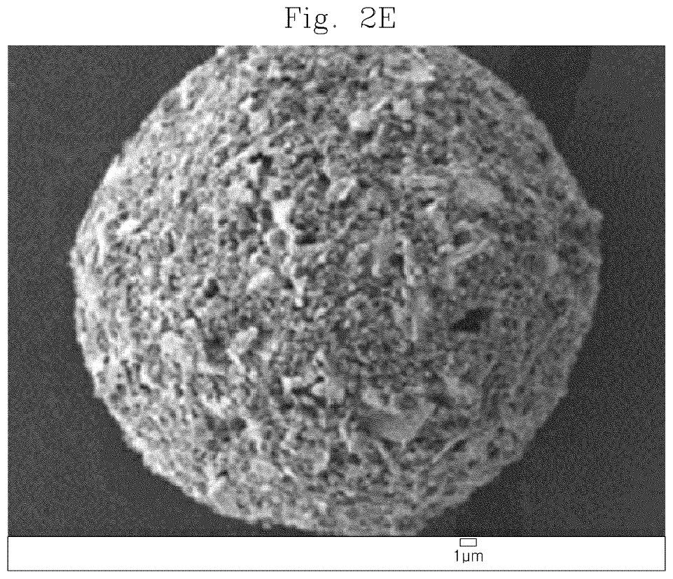

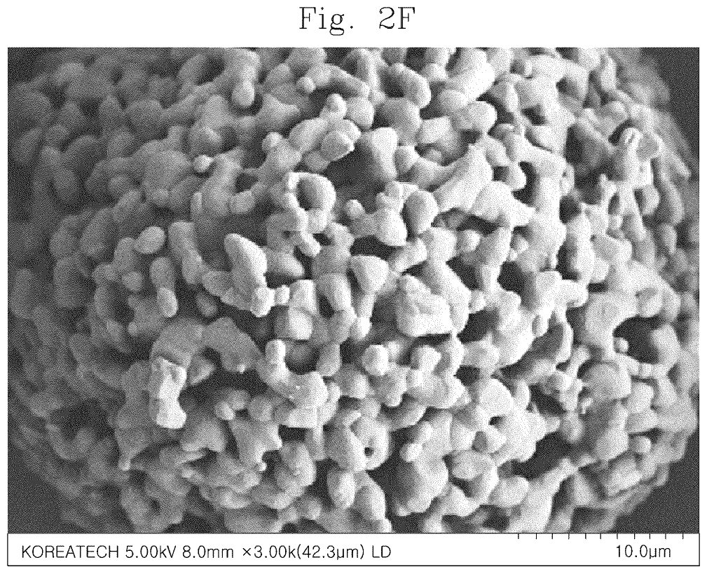

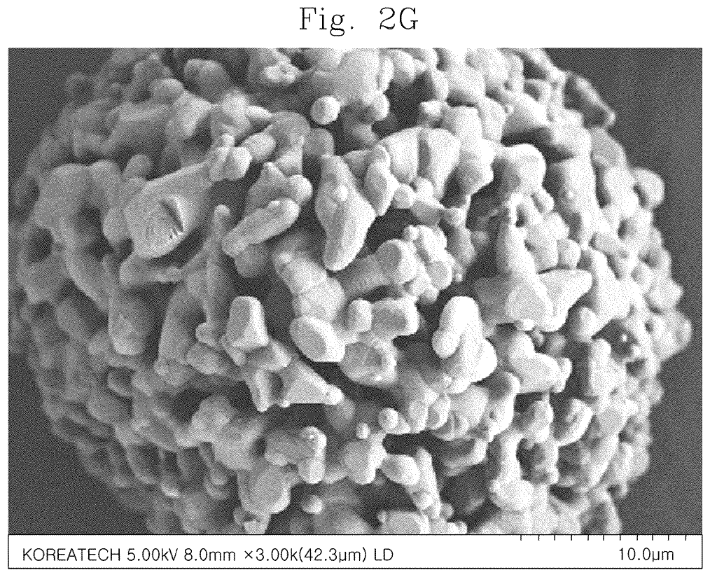

FIGS. 2A to 2G show SEM images of the granule surfaces according to the examples and comparative examples of the present disclosure.

FIG. 2A shows the granule surface image of Comparative Example 1, FIG. 2B of Comparative Example 2, FIG. 2C of Comparative Example 3, FIG. 2D of Example 1, FIG. 2E of Example 2, FIG. 2F of Example 3, and FIG. 2G of Comparative Example 4. FIGS. 2A to 2G indicate field emission scanning electron microscope (FE-SEM) images, and JSM-IT700HR model (JEOL) was used. The magnification was set to 3,000×, and the electron beam voltage was set to 5 kV.

FIGS. 2A to 2G illustrate powder morphology images of the examples and comparative examples. Referring to Example 3 and Comparative Example 4, greater grain growth was observed in Comparative Example 4 with a magnesia content exceeding 70 vol %. Example 3 allowed coating, but Comparative Example 4 did not allow coating. Comparative Example 2 containing magnesia in an amount below 10 vol % showed no great surface difference compared with Comparative Example 1.

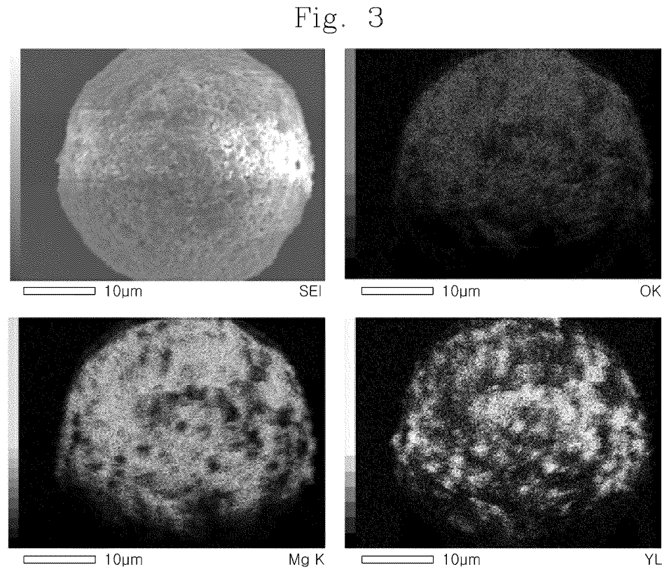

FIG. 3 shows EDS images of a granule according to an example of the present disclosure.

For energy dispersion spectroscopy (EDS), JSM-IT700HR model (JEOL) was used. The magnification was set to 3,000×, and the electron beam voltage was set to 5 kV. A small amount of granular powder was sampled and attached onto a carbon tape, coated with gold, and analyzed.

Referring to FIG. 3, the EDS images were for Example 3, and different types of materials (yttria powder and magnesia powder) were uniformly mixed on the granular powder.

Table 3 shows XRD data of the granular powders according to the examples and comparative examples of the present disclosure.

The X-ray diffraction (XRD) analysis was performed using Empyrean XRD instrument (Malvern Panalytical). Cu was used for an X-ray tube, and for X-ray generation, the voltage was set to 40 kV and the current was set to 30 mA. A theta-2theta scan was conducted over the 10° to 90° range. The fraction or reference intensity ratio (RIR) was measured by the RIR method. The fraction indicates the relative ratio of strongly appearing peaks. The d-value corresponds to the distance between lattice planes (Å) according to the peak position.

TABLE 3

| | XRD | | | | |
|---|---|---|---|---|---|
| | | | Peak | | |
| | | Crystalline | position | | Fraction |
| Condition No. | Substance | structure | (°) | d (Å) | (%) |
| Comparative | Y₂O₃ | Cubic | 29.158 | 3.06025 | 100 |
| Example 1 | | | | | |
| Comparative | Y₂O₃ | Cubic | 29.212 | 3.05470 | 100 |
| Example 2 | | | | | |
| Comparative | Y₂O₃ | Cubic | 29.150 | 3.06131 | 93 |
| Example 3 | MgO | Cubic | 42.871 | 2.10855 | 7 |
| Example 1 | Y₂O₃ | Cubic | 29.152 | 3.06170 | 79 |
| | MgO | Cubic | 42.865 | 2.10789 | 21 |
| Example 2 | Y₂O₃ | Cubic | 29.149 | 3.06111 | 58 |
| | MgO | Cubic | 42.866 | 2.10800 | 42 |
| Example 3 | Y₂O₃ | Cubic | 29.153 | 3.06074 | 35 |
| | MgO | Cubic | 42.886 | 2.10700 | 65 |
| Comparative | Y₂O₃ | Cubic | 29.158 | 3.06025 | 12 |
| Example 4 | MgO | Cubic | 42.909 | 2.10600 | 88 |

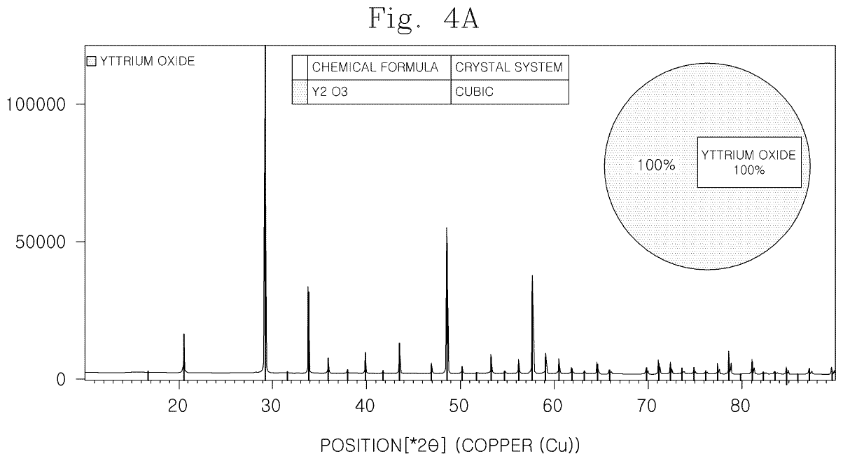

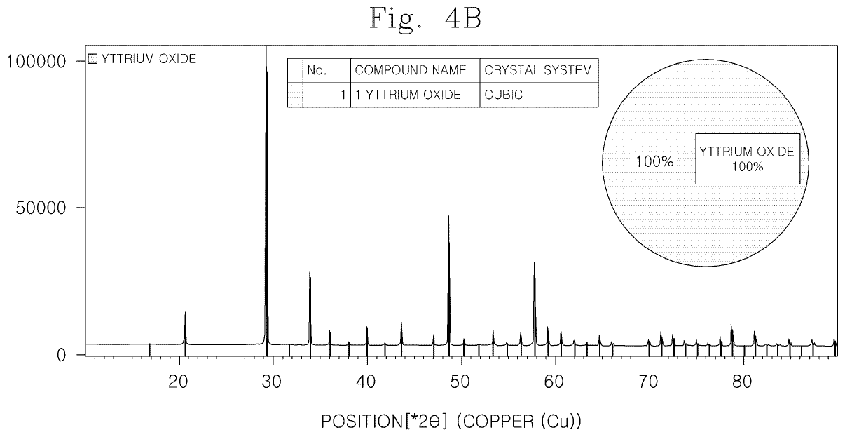

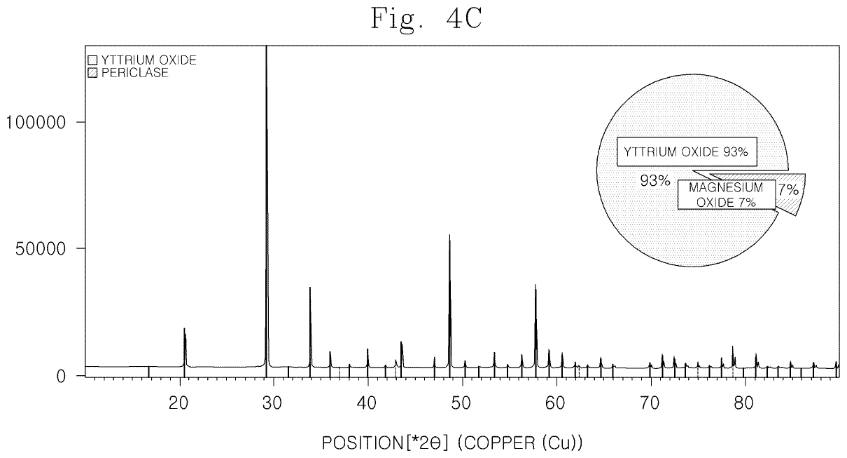

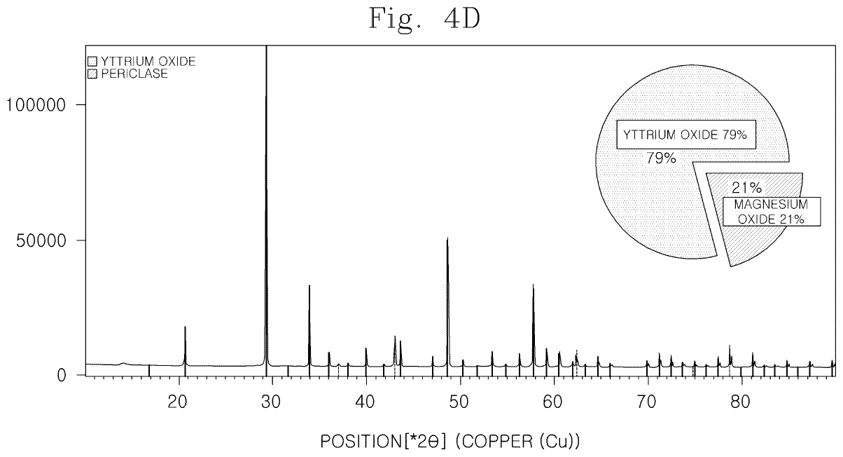

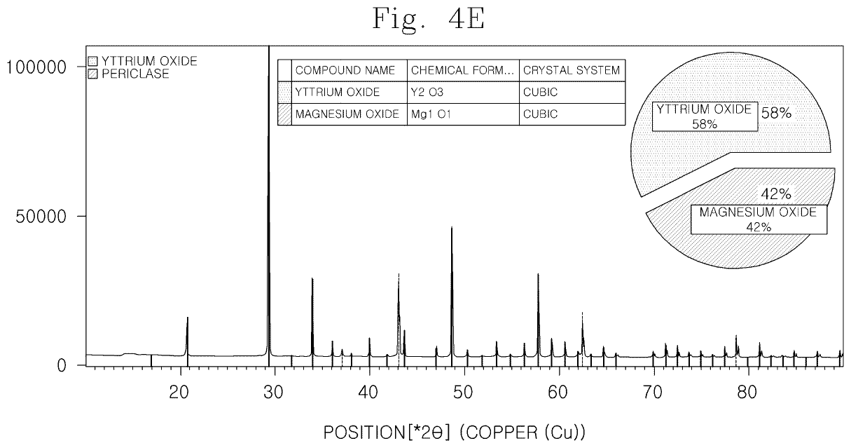

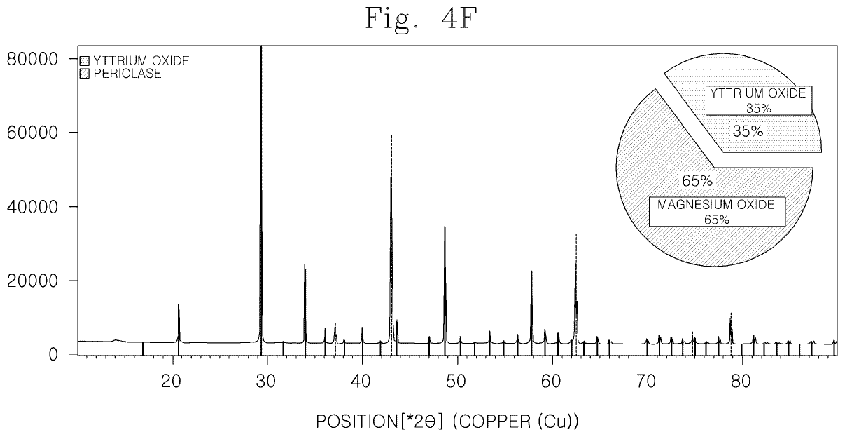

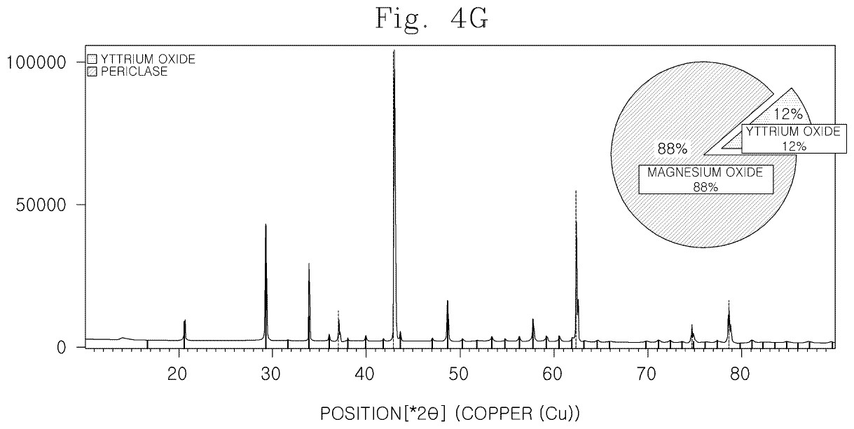

FIGS. 4A to 4G show graphs illustrating the XRD analysis results of the granular powders according to the examples and comparative examples of the present disclosure.

FIG. 4A shows the graph of Comparative Example 1, FIG. 4B of Comparative Example 2, FIG. 4C of Comparative Example 3, FIG. 4D of Example 1, FIG. 4E of Example 2, FIG. 4F of Example 3, and FIG. 4G of Comparative Example 4.

Compared with the conventional yttria powder (Comparative Example 1), Comparative Example 3 was observed to contain two types of powders (yttria and magnesia powders), which were not combined, distributed on the granule surface and, even after heat treatment, to have 30 to 80% of Y₂O₃ cubic crystalline phase and 20 to 70% of MgO cubic phase rather than a mixed phase.

The heat treatment was performed to remove organic additives introduced for granule manufacture and to provide flowability and strength for maintaining granule shape and enabling coating.

The granular powders of the examples and comparative examples were used to form coating layers by atmospheric plasma spraying (APS). Particularly, Al 6061 substrates (20 mm×20 mm×3 mm) were used as base substrates. The plasma-spraying conditions for coating formation are shown in Table 4.

TABLE 4

| | | | | Powder | |
|---|---|---|---|---|---|
| | | | | delivery | Substrate |
| | Voltage | Current | Power | rate | distance |
| Classification | (V) | (A) | (kW) | (g/min) | (mm) |
| Comparative | 60-80 | 400-700 | 35 | 10 | 130-180 |
| Example 1 | | | | | |
| Comparative | | | | 8.2 | |
| Example 3 | | | | | |
| Example 1 | | | | 9.1 | |
| Example 2 | | | | 9.8 | |
| Example 3 | | | | 9.5 | |
| Comparative | | | | 9.3 | |
| Example 4 | | | | | |

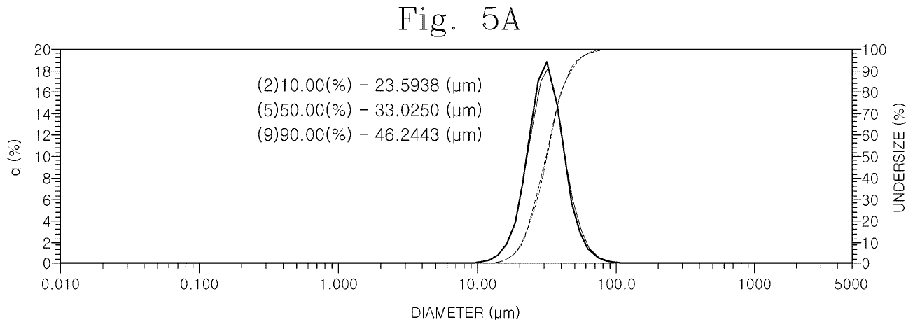

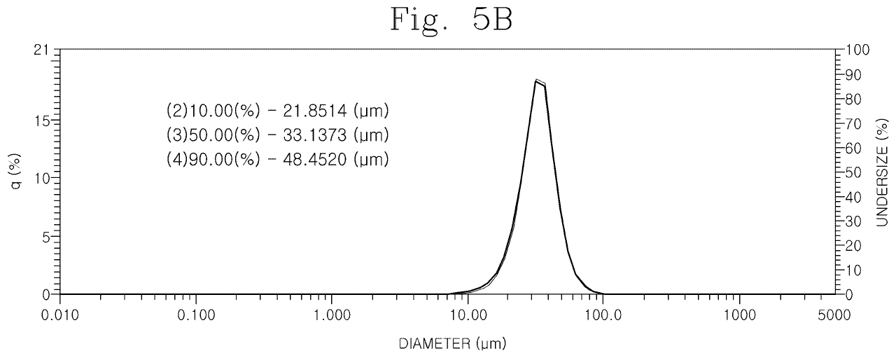

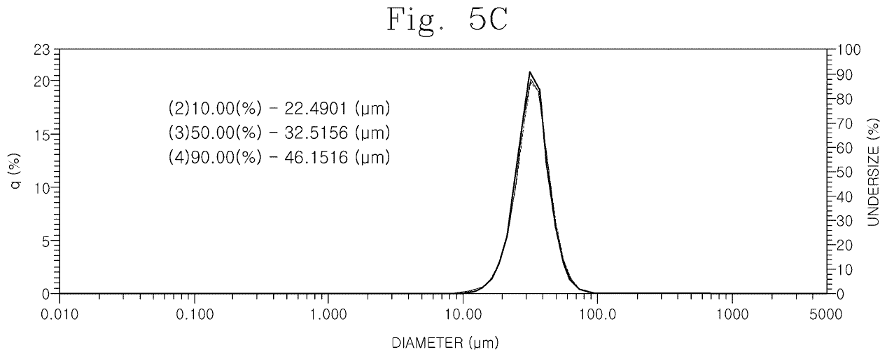

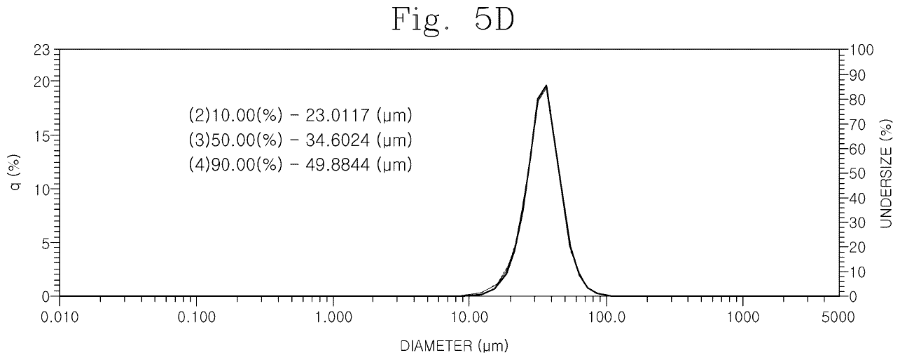

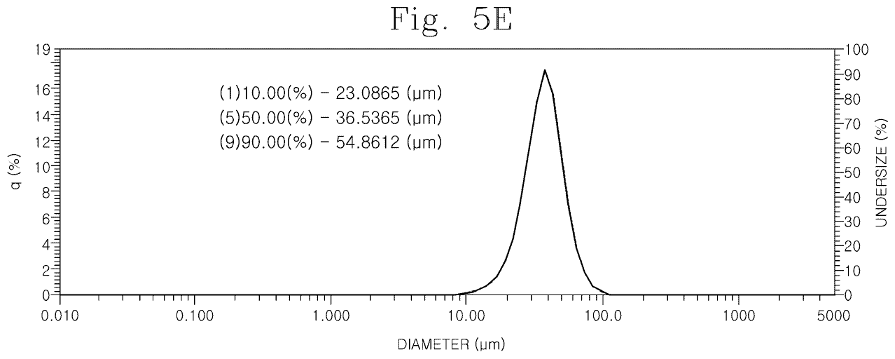

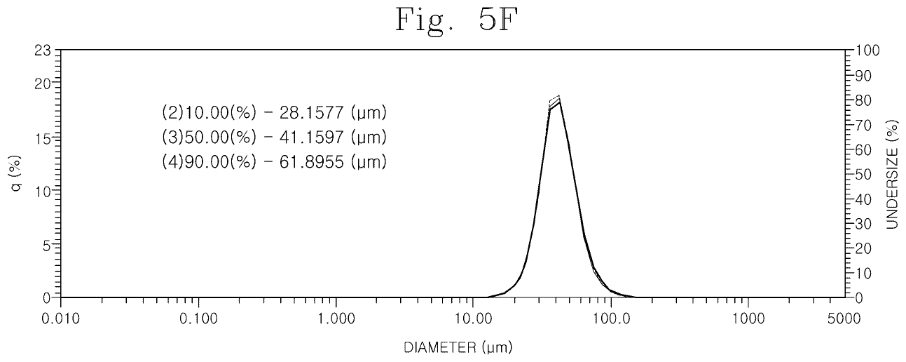

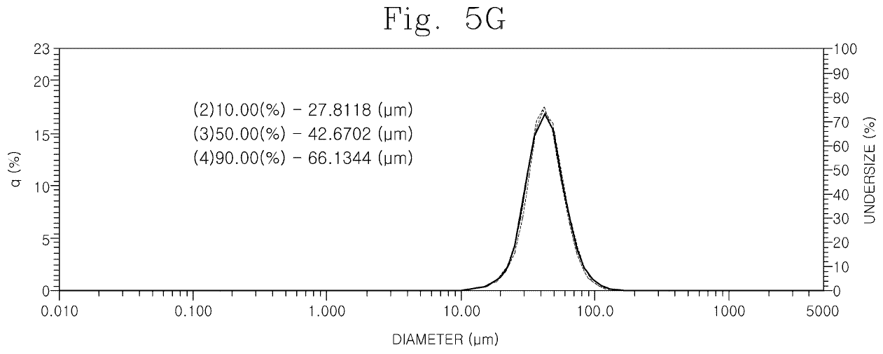

Table 5 shows the PSA analysis results of the examples and comparative examples of the present disclosure, and FIGS. 5A to 5G show graphs illustrating the PSA analysis results. PSA was measured by wet analysis using LA-960 model (HORIBA). The refractive index values applied were 2.111-0.100i for Y₂O₃, 1.760-0.100i for MgO, and 1.333 for solvent DI water, and measurements were conducted in the transmittance range of 95 to 70% without using ultrasound waves and dispersants.

FIG. 5A shows the graph of Comparative Example 1, FIG. 5B of Comparative Example 2, FIG. 5C of Comparative Example 3, FIG. 5D of Example 1, FIG. 5E of Example 2, FIG. 5F of Example 3, and FIG. 5G of Comparative Example 4.

D10, D50, and D90 represent characteristic particle sizes in the cumulative volume distribution of particle sizes, wherein D10 indicates the particle size at the first 10% of the cumulative volume distribution, and D50, also called the median particle size, indicates the particle size at 50% of the cumulative volume distribution. D90 indicates the particle size at 90% of the cumulative volume distribution.

TABLE 5

| | |
|---|---|
| Condition Number | Grain size (μm) |

| | | |
|---|---|---|
| Comparative | D10 | 23.5 |
| Example 1 | D50 | 33.0 |
| | D90 | 46.2 |
| Comparative | D10 | 21.8 |
| Example 2 | D50 | 33.1 |
| | D90 | 48.4 |
| Comparative | D10 | 22.4 |
| Example 3 | D50 | 32.5 |
| | D90 | 46.1 |
| Example 1 | D10 | 23.0 |
| | D50 | 34.6 |
| | D90 | 49.8 |
| Example 2 | D10 | 23.0 |
| | D50 | 36.5 |
| | D90 | 54.8 |
| Example 3 | D10 | 28.7 |
| | D50 | 41.1 |
| | D90 | 61.8 |
| Comparative | D10 | 27.8 |
| Example 4 | D50 | 42.6 |
| | D90 | 66.13 |

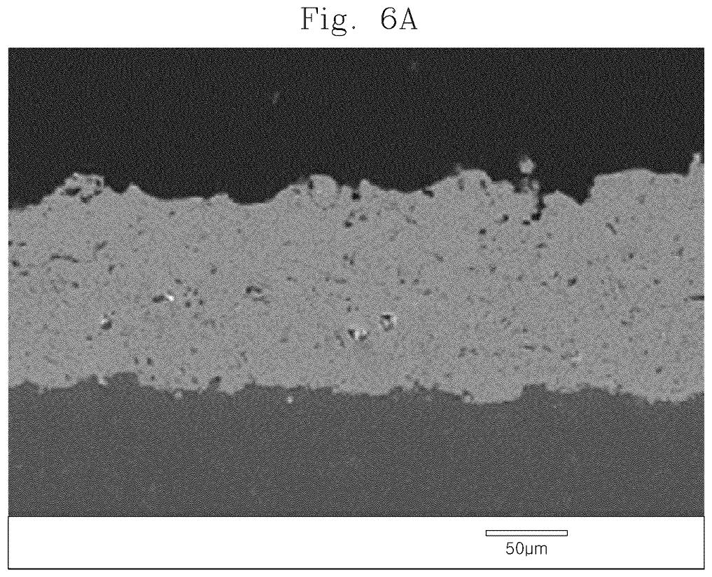

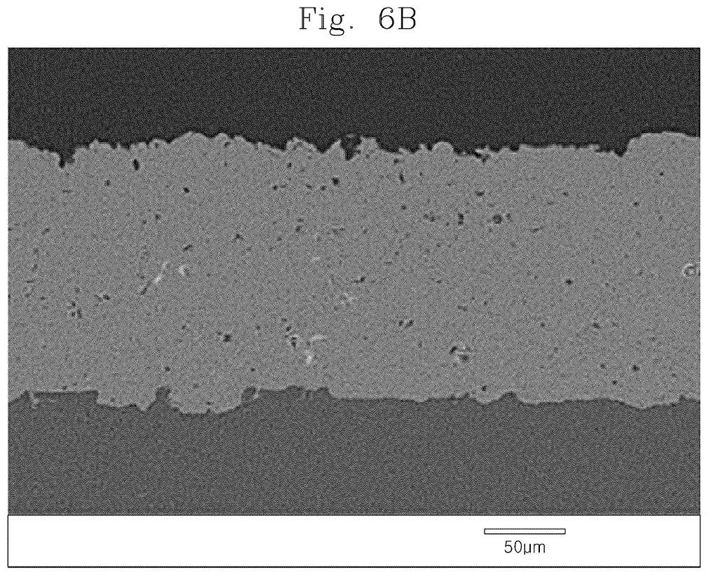

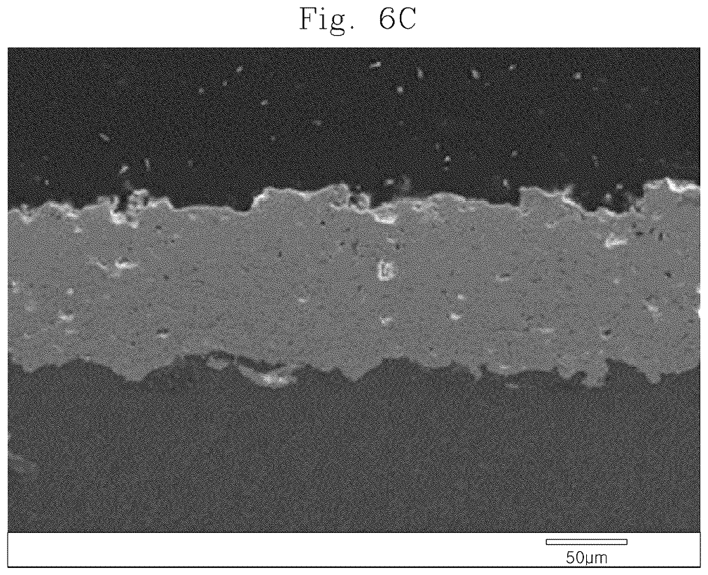

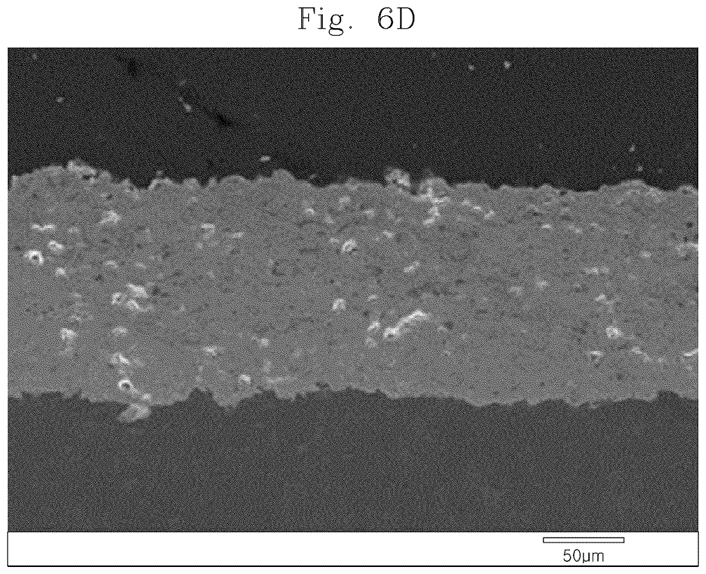

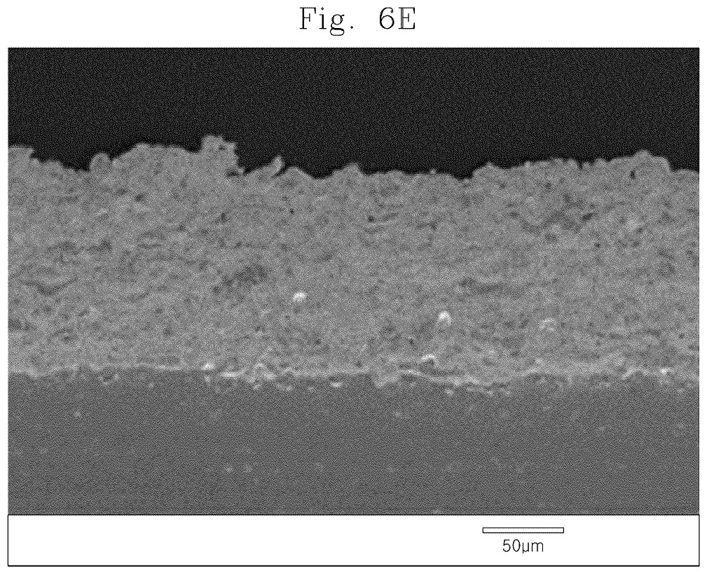

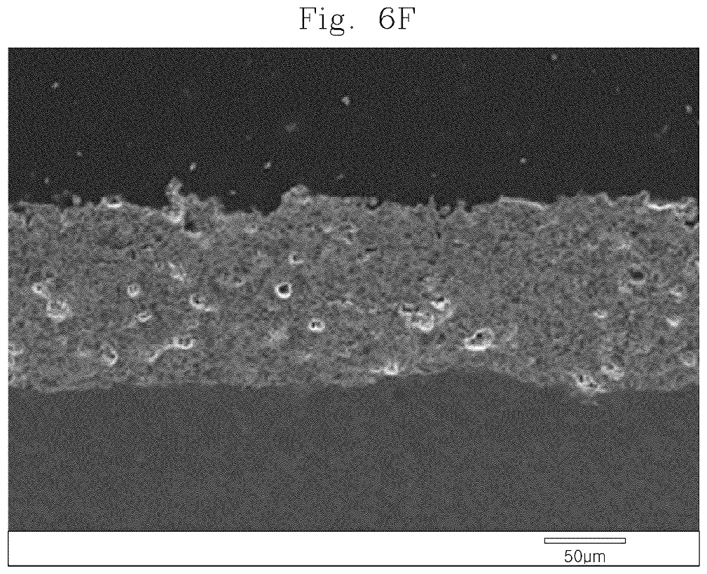

FIGS. 6A to 6F show SEM images of coating layer sections for the examples and comparative examples of the present disclosure.

With respect to SEM, the magnification was set to 300× and the electron beam voltage was set to 20 kV. The hardness (Hv) values of Comparative Examples 1, 2, and 3 and Examples 1, 2, and 3 were measured to be 450 Hv, 450 Hv, 600 Hv, 650 Hv, 780 Hv, and 700 Hv, respectively. Comparative Example 4 could not be measured for hardness due to impossibility of coating.

Referring to FIGS. 6A to 6F, when the cross-sections of the coating layers were observed by SEM after atmospheric plasma spraying (APS), a clear phase separation between yttria and magnesia was confirmed since yttria and magnesia are not mutually soluble in the solid state.

However, as a result of atmospheric plasma spraying (APS) coating, the grain size of the coating layer was 0.1 μm up to 3 μm under the conditions in Comparative Examples 1 and 2, but the grain size was reduced to 0.1 μm up to 0.4 μm under the conditions in Example 2, indicating that the grain size can be controlled.

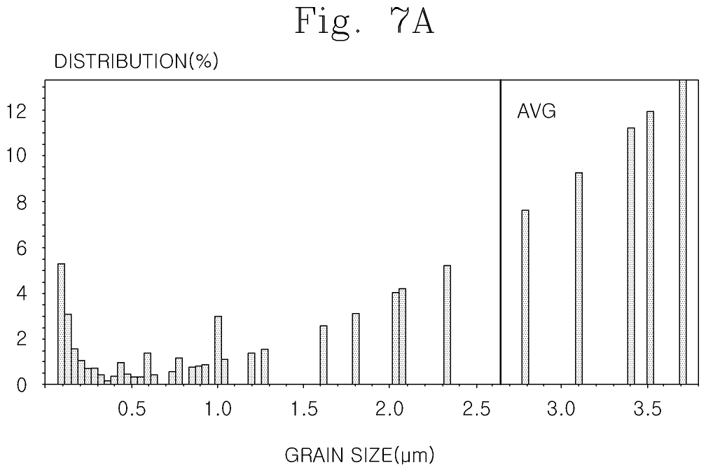

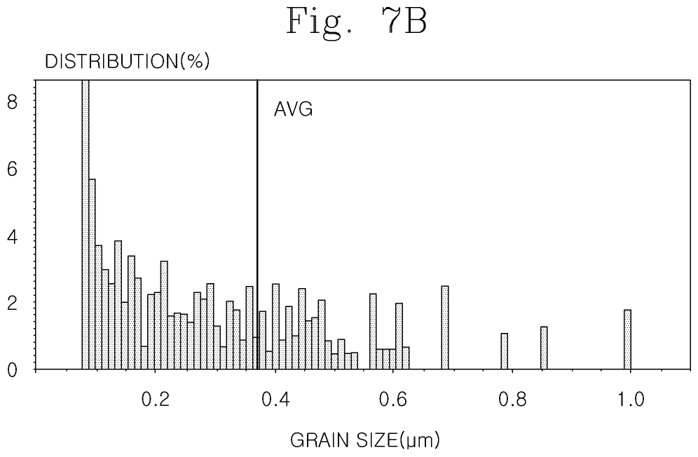

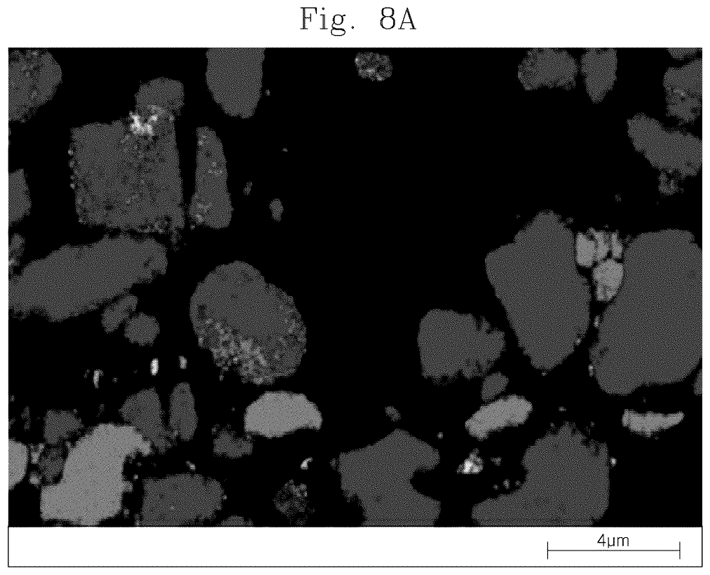

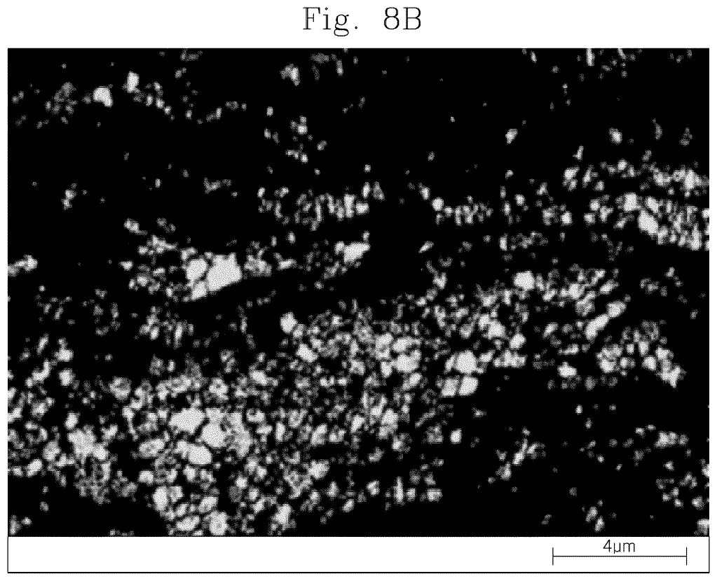

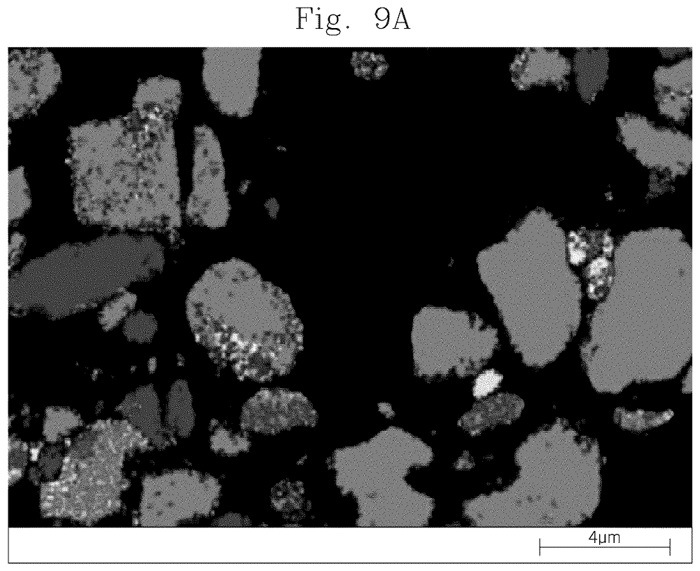

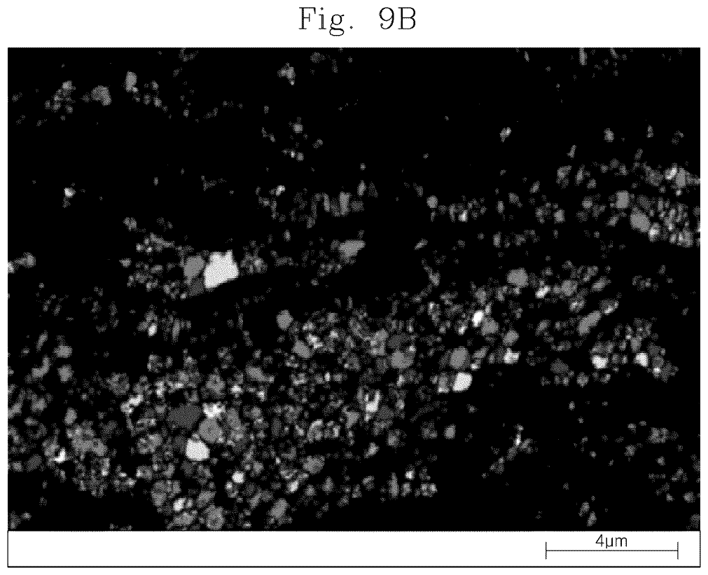

FIGS. 7A and 7B illustrate the grain size distributions for Comparative Example 1 and Example 2, and FIGS. 8A and 8B illustrate crystalline structures for Comparative Example 1 and Example 2, and FIGS. 9A and 9B illustrate the crystallographic orientations for Comparative Example 1 and Example 2. Measurements were conducted using electron backscatter diffraction (EBSD).

FIGS. 8A and 9A show the results for Comparative Example 1, and FIGS. 8B and 9B show the results for Example 2. Referring to FIGS. 7A and 7B, the average grain size of Comparative Example 1 was 2.64 μm, but the average grain size of Example 2 was 0.37 μm, which was reduced compared with that of Comparative Example 1. Referring to FIGS. 8A and 8B, the crystalline structure of Example 2 was further micronized than that of Comparative Example 1. Referring to FIGS. 9A and 9B, the crystallographic orientation of Example 2 was distributed more uniformly than that of Comparative Example 1.

The yttria (Y₂O₃)-magnesia (MgO) mixed powder for coating manufactured using a spray granulation process according to an embodiment of the present disclosure exhibited a reduction in contaminant particles through micronization of the crystalline phase in the coating layer compared with the conventional yttria (Y₂O₃) powder. Furthermore, compared with the conventional yttria (Y₂O₃) coating layer, the mixing with magnesia (MgO) can enhance the strength of the coating layer and lower the manufacturing cost.

The use of yttria (Y₂O₃)-magnesia (MgO) mixed powder for coating can achieve an excellent plasma-resistant coating on a component with a complex shape, and the formation of the plasma-resistant coating on a substrate with high impact resistance can achieve overcoming the limitations of sintered bodies. Furthermore, a coating layer with suppressed grain growth can lead to grains smaller than that in the conventional yttria coating layer as well as reduced surface roughness. This can improve process stability and yield by generating smaller and fewer contaminant particles during plasma etching than conventional coatings to thereby reduce the adverse effects of such particles.

The specified matters and limited embodiments and drawings such as specific elements in the present invention have been disclosed for broader understanding of the present invention, but the present invention is not limited to the embodiments, and various modifications and changes are possible by those skilled in the art without departing from an essential characteristic of the present invention. The spirit of the present disclosure is defined by the appended claims rather than by the described embodiments above, and all changes and modifications that fall within metes and bounds of the claims, or equivalents of such metes and bounds are therefore intended to be embraced by the range of the spirit of the present disclosure. Additionally, the respective embodiments may be combined and operated together as needed.

What is claimed is:

1. A method for manufacturing a composite powder, the method comprising:
preparing a slurry in which a yttria powder, a magnesia powder, a solvent, and an organic additive are mixed;
performing ball milling on the slurry; and
drying the slurry to produce a granular powder containing the yttria powder and the magnesia powder,
wherein the granular powder contains yttria crystals and magnesia crystals.

2. The method of claim 1, wherein the slurry is spray-dried to produce the granular powder.

3. The method of claim 1, wherein the organic additive is contained in an amount of 1 to 6 wt % relative to the total weight of the yttria powder and the magnesia powder.

4. The method of claim 3, wherein the organic additive contains a dispersant and a binder, and relative to 100 wt % of the organic additive, the dispersant is contained in an amount of 30 to 90 wt % and the binder is contained in an amount of 10 to 70 wt %.

5. The method of claim 4, wherein the binder is at least one of PVA, PVB, PVP, and PEO.

6. The method of claim 1, wherein the RIR of the yttria powder to the magnesia powder contained in the granular powder is 30:70 to 80:20.

7. The method of claim 1, wherein the RIR of the yttria powder to the magnesia powder contained in the granular powder is 35:65 to 79:21.

8. The method of claim 1, wherein relative to a total of 100 wt % of the yttria powder, the magnesia powder, and the solvent, the sum of the yttria powder and the magnesia powder is 30 to 70 wt %.

9. The method of claim 1, wherein in the granular powder, relative to a total of 100 vol % of the yttria powder and the magnesia powder, the volume ratio (vol %) of the yttria powder to the magnesia powder is 30:70 to 70:30.

10. A composite granular powder, comprising a yttria powder and a magnesia powder, wherein the volume ratio (vol %) of the yttria powder to the magnesia powder is 30:70 to 70:30.

11. The composite granular powder of claim 10, wherein the granular powder is produced by spray-drying a slurry in which the yttria powder, the magnesia powder, a solvent, and an organic additive are mixed.

12. The composite granular powder of claim 10, wherein the RIR of the yttria powder to the magnesia powder contained in the granular powder is 30:70 to 80:20.

13. The composite granular powder of claim 10, wherein the RIR of the yttria powder to the magnesia powder contained in the granular powder is 35:65 to 79:21.
